(19) United States
(12) Patent Application Publication
(10) Pub. No.: US 2008/0091556 A1
(43) Pub. Date: Apr. 17, 2008

(54) WEB-BASED COMMUNICATION TOOL FOR PET OWNERS

(76) Inventor: Gerard N. ALTIERI, Jupiter, FL (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/872,278

(22) Filed: Oct. 15, 2007

Related U.S. Application Data
(60) Provisional application No. 60/829,401, filed on Oct. 13, 2006.

(51) Int. Cl. G06Q 30/00

(52) U.S. Cl. 705/26; 705/1

(57) ABSTRACT

The subject application is directed to a system and method for interactive communication for associated pet owners. Selection data inclusive of attraction data is first received from multiple pet owners. Selection data with respect to the multiple associated pet owners, is associated with at least one attraction module. In one embodiment, the attraction module is selected from the group consisting of meeting friends, pet advice, veterinarian answers, memorial; postings, weekly pet horoscopes, pet fashions for sale, pets in the news, and hero of the week. Next, a user interface is generated in accordance with the performed association, and displayed to the multiple pet owners. Interaction is then accomplished between the multiple associated pet owners via the user interface from remote locations.

### CROSS-REFERENCE TO RELATED APPLICATIONS

This applications claims priority to U.S. Provisional Patent Application Ser. No. 60/829,401, filed Oct. 13, 2006, the entirety of which is incorporated herein.

### BACKGROUND

The subject application is directed to a web communication tool for pet owners. More particularly, the subject application is directed to a system and method that provide an interactive communication tool for pet owners allowing for pet lovers around the world to communicate over the Internet using an interactive website.

Many pet owners become deeply attached to their pets, and are willing to spend considerable money providing for their maintenance and care. The industry serving these pet owners is large and diverse. A significant portion of the pet industry is devoted to manufacturing supplies to maintain, nurture, amuse and occupy pets. In recent years, the Internet, and particularly the World Wide Web, is increasingly being used for transmission of various information, such as financial information, commercial information, personal and business information, as well as for communication between users with mutual interests, such as sports fans, book fans, pet fans, and the like. Previously known websites for pet owners provide free Internet dating for pet owners and/or bridging communication between animals and their humans. Other previously known websites provide resources for pet owners, or information on animals for sale. However, these websites suffer misspellings, errors, and do not have interactive abilities.

### SUMMARY OF INVENTION

In accordance with the subject application, there is provided an interactive communication tool for pet owners.

Further, in accordance with the subject application, there is provided a system and method allowing for pet owners around the world to communicate over the Internet using an interactive website.

Yet further, in accordance with the subject application, there is provided an interactive website that offers like minded pet-lovers around the world a way to connect via the Internet. The system and method of the subject application allows visitors to converse person to person or pet to pet (in the third person). In addition, fun-natured humor is the cornerstone of the website of the subject application.

Still further, in accordance with the subject application, there is provided a system for interactive communication for associated pet owners comprising means adapted for receiving, from a plurality of associated pet owners, selection data inclusive of attraction data. The system of the subject application further comprises association means adapted for associating at least one attraction module with received selection data with respect to the plurality of associated pet owners. In addition, the system comprises means adapted for generating at least one user interface corresponding to the at least one attraction module in accordance with association performed by the association means. Further comprised in the system is means adapted for displaying, to the plurality of associated pet owners, the at least one user interface corresponding to the at least one attraction module, and means adapted for accomplishing interaction between the plurality of associated pet owners via the at least one user interface from remote locations.

In accordance with one embodiment of the subject application, the at least one attraction module is selected from the group consisting of meeting friends, pet advice, veterinarian answers, memorial postings, pet fashions for sale, weekly pet horoscopes, pets in the news, and hero of the week.

Further, in accordance with one embodiment of the subject application, the at least one attraction module is representative of a link relating to at least one of the group consisting of pet rescue, pet breeding, and pet adoption.

Still further, in accordance with one embodiment of the subject application, the at least one attraction module is representative of a pet beauty contest selected from the group consisting of monthly pet's photos, pet-owner look a-likes, and pets dressed up, wherein the pet beauty contest is judged by pet fans.

Yet further, in accordance with one embodiment of the subject application, the at least one attraction module is representative of online text-based communication, and is selected from the group consisting of frequently asked questions, problem solving, training and handling tips, and synchronous conferencing.

Yet further, in accordance with one embodiment of the subject application, the at least one user interface is comprised of a plurality of interface display frames in a hierarchical structure.

Still further, in accordance with one embodiment of the subject application, there is provided a method for interactive communication for associated pet owners in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited for to carry out the subject application. As it will be realized, the subject application is capable of other different embodiments and its several details are capable of modifications in various obvious aspects all without departing from the scope of the subject application. Accordingly, the drawings and description will be regarded as illustrative in nature and not as restrictive.

### BRIEF DESCRIPTION OF THE DRAWINGS

The subject application is described with reference to certain figures, wherein:

FIG. 1 is an overall diagram of the system for interactive communication for associated pet owners according to one embodiment of the subject application;

FIG. 2 is a block diagram illustrating a server for use in the system for interactive communication for associated pet owners according to one embodiment of the subject application; and

FIG. 3 is a flowchart illustrating a method for interactive communication for associated pet owners according to one embodiment the subject application.

FIG. 4 illustrates a fragment of a user interface for use in the system and method for interactive communication for associated pet owners according to one embodiment the subject application.

### DETAILED DESCRIPTION OF THE PREFERRED EMBODIMENT

The subject application is directed to a web communication tool for pet owners. More particularly, the subject application is directed to a system and method that provide an interactive communication tool for pets and their owners allowing for pet lovers around the world to communicate over the Internet using an interactive website.

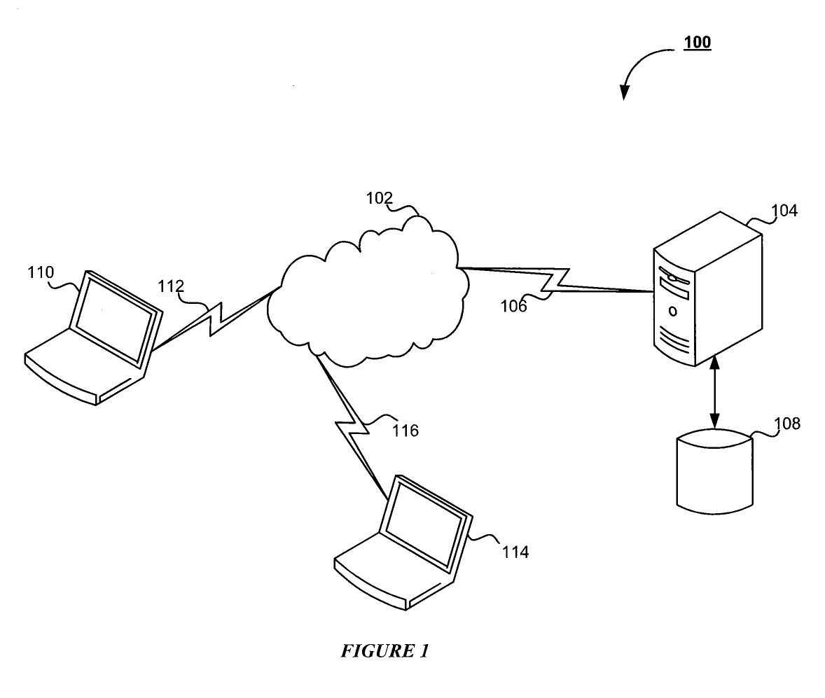

Referring now to FIG. 1, there is shown an overall diagram of the system 100 for interactive communication for associated pet owners accordance with the subject application. As shown in FIG. 1, the system 100 employs a distributed computing environment, represented as a computer network 102. It will be appreciated by those skilled in the art that the computer network 102 is any distributed communications environment known in the art capable of enabling the exchange of data between two or more electronic devices. Those skilled in the art will further appreciate that the network 102 is any computer network known in the art including, for example and without limitation, a virtual area network, a local area network, a personal area network, the Internet, an intranet, a wide area network, or any suitable combination thereof. Preferably, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. In accordance with the preferred embodiment of the subject application, the computer network 102 is the Internet.

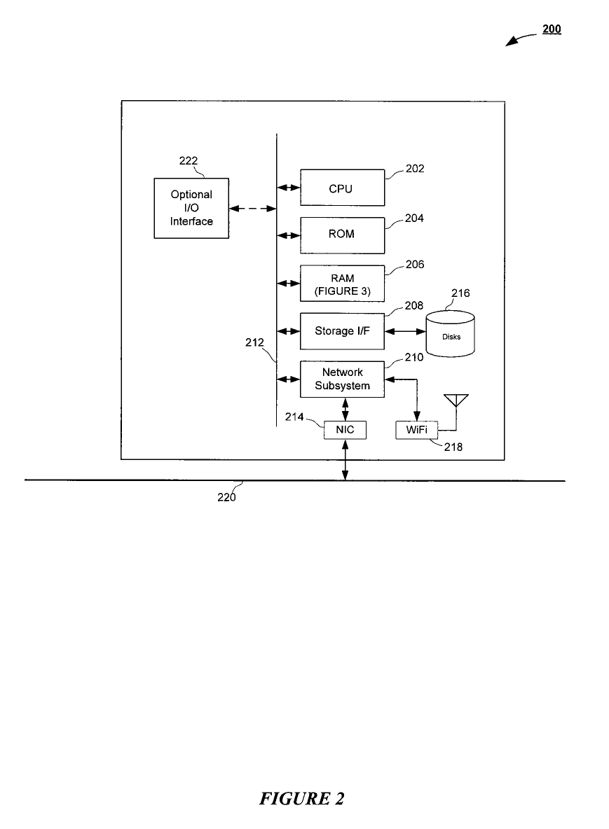

The system 100 further includes a server 104, communicatively coupled to the computer network 102 via a communications link 106. It will be appreciated by those skilled in the art that the server 104 comprises hardware, software, and combinations thereof suitably adapted to provide one or more services, web-base applications, storage options, or the like, to networked devices. In accordance with one embodiment of the subject application, the server 104 includes various components, implemented as hardware, software, or a combination thereof, for managing the performance of web services processes accessed via the computer network 102. The communications link 106 is any suitable means of data communication known in the art, including, for example and without limitation, infrared, optical, a proprietary communications network, the public switched telephone network, BLUETOOTH, WiMax, 802.11a, 802.11b, 802.11g, or 802.11(x), or any other suitable wire-based or wireless data transmission means known in the art. The functioning of the server 104 will better be understood in conjunction with the block diagram illustrated in FIG. 2, explained in greater detail below.

Communicatively coupled to the server 104 is a data storage device 108. In accordance with the preferred embodiment of the subject application, the data storage device 108 is any mass storage device known in the art including, for example and without limitation, magnetic storage drives, a hard disk drive, optical storage devices, flash memory devices, or any suitable combination thereof. In the preferred embodiment, the data storage device 108 is suitably adapted to store data related to meeting friends, pet advice, veterinarian answers, memorial postings, weekly pet horoscopes, pet fashions for sale, pets in the news, and hero of the week. As will be recognized by a skilled artisan, the data storage device 108 is further suitably adapted to store data representative of links relating to pet rescue, pet breeding, pet adoption, and the like. A skilled artisan will further appreciate that the data storage device 108 is further suitably adapted to store data representative of a pet beauty contest, such as monthly pet's photos, pet-owner look a-likes, pets dressed up, and the like. The data storage device 108 is further suitably adapted to store data representative of online text-based communication, such as frequently asked questions, problem solving, training and handling tips, synchronous conferencing, and the like. A skilled artisan will understand that the data storage device 108 is further suitably adapted to store data representative of identification data with respect to multiple pet owners, as known in the art. It will be appreciated by those skilled in the art that while illustrated in FIG. 1 as being a separate component of the system 100, the data storage device 108 is capable of being implemented as internal storage component of the server 104, or the like, such as, for example and without limitation, an internal hard disk drive, or the like. As will be recognized by a skilled artisan, the data storage device 108 is also capable of implementation as a Storage Area Network (SAN).

As shown in FIG. 1, the system 100 also includes a first user, or pet owner device 110, suitably adapted to communicate with the server 104 via the computer network 102. Preferably, the first pet owner device 110 is communicatively coupled to the computer network 102 via a suitable communications link 112. Further shown in FIG. 1, is a second user device 114, suitably adapted to communicate with the server 104 via the computer network 102. Preferably, the second pet owner device 114 is communicatively coupled to the computer network 102 via a suitable communications link 116. It will be appreciated by those skilled in the art that the first and second pet owner devices 110, 114, respectively, are depicted each in FIG. 1 as a laptop computer for illustration purposes only. As the skilled artisan will understand, the pet owner devices 110, 114 shown in FIG. 1 are representative of any personal computing device known in the art, including, for example and without limitation, computer workstation, a personal computer, a personal data assistant, a web-enabled cellular telephone, a smart phone, or other web-enabled electronic device. As will be further recognized by those skilled in the art, the pet owner devices 110, 114 are representative of a plurality of pet owner devices that are capable of being included in the system 100 without departing from the scope of the subject application.

The communications links 112 and 116 are any suitable channels of data communications known in the art including, but not limited to wireless communications, for example and without limitation, BLUETOOTH, WiMax, 802.11a, 802.11b, 802.11g, 802.11(x), a proprietary communications network, infrared, optical, the public switched telephone network, or any suitable wireless data transmission system, or wired communications known in the art. Preferably, the pet owner devices 110 and 114 are suitably configured to communicate with the server 104 over the computer network 102 using a web browser or other suitable thin client interface. As will be understood by those skilled in the art, a web browser is any software application, known in the art, enabling the pet owner devices 110 and 114 to communicate with the Internet. Suitably browsers include, for example and without limitation, OPTERA, INTERNET EXPLORER, NETSCAPE NAVIGATOR, MOZILLA FIREFOX, or the like.

Referring now to FIG. 2, illustrated is a representative architecture of a suitable server 200 on which operations of the subject system are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration, and other routines or data used for operation of the server 200.

Also included in the server 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the server 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the server 200 to communicate to other devices. The network interface subsystem 210 suitably interfaces with one or more connections with external devices to the server 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the server 200 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 222 as will be appreciated by one of ordinary skill in the art.

In operation, in accordance with one example embodiment of the subject application, the server 104 receives selection data inclusive of attraction data from multiple associated pet owners, represented in FIG. 1 by the first pet owner device 110 and the second pet owner device 114. As will be recognized by those skilled in the art, attraction data is capable of being related to meeting friends, pet advice, veterinarian answers, memorial postings, weekly pet horoscopes, pet fashions for sale, pets in the news, and hero of the week. As will be further recognized by a skilled artisan, the attraction data is capable of being representative of links relating to pet rescue, pet breeding, pet adoption, and the like. A skilled artisan will further appreciate that the attraction data is further suitable capable of being representative of a pet beauty contest, such as monthly pet's photos, pet-owner look a-likes, pets dressed up, and the like. The attraction data is further advantageously capable of being representative of online text-based communication, such as frequently asked questions, problem solving, training and handling tips, synchronous conferencing, and the like. A skilled artisan will understand that the attraction data is further capable of being representative of identification data with respect to multiple pet owners, as known in the art.

Selection data inclusive of attraction data is then stored in a memory associated with a respective component of the system 100, such as data storage device 108, or respective internal memory associated therewith. A component of the server 104 associates the selection data with respect to the plurality of associated pet owners, with at least one attraction module. A component of the server 104 then generates at least one user interface corresponding to the at least one attraction module in accordance with association performed by the respective component of the server 104. The user interface is, preferably, comprised of a plurality of interface display frames in a hierarchical structure, as known in the art. The user interface generated by the server 104 is then displayed to associated pet owners on respective pet owner devices 110, 114, providing interaction between the plurality of associated pet owners from remote locations of respective pet owner devices 110, 114.

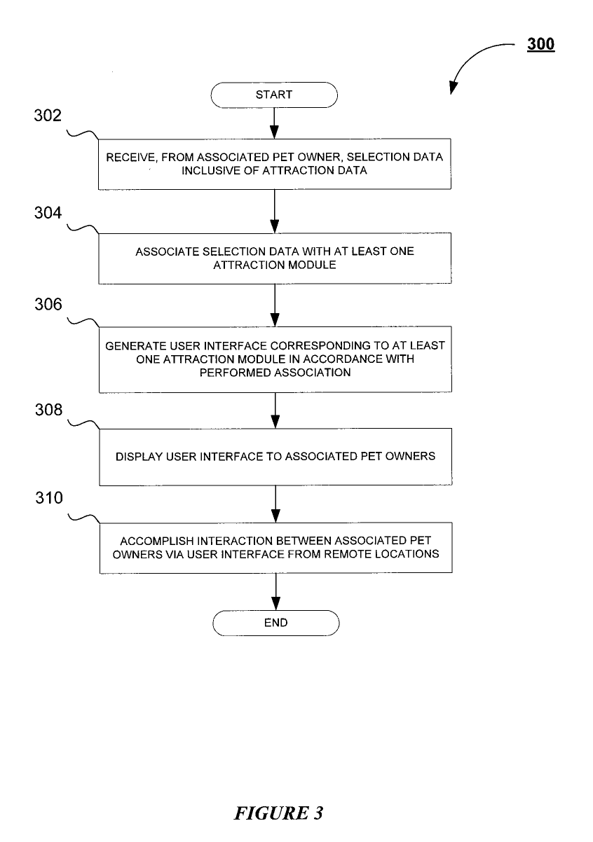

The skilled artisan will appreciate that the subject 100 and components described above with respect to FIG. 1 and FIG. 2 will be better understood when viewed in conjunction with the methodology depicted in FIG. 3, discussed hereinafter. Turning now to FIG. 3, there is shown a flowchart 300 illustrating the method for interactive communication for associated pet owners in accordance with one embodiment of the subject application. Beginning at step 302, the server 104 receives selection data inclusive of attraction data from multiple associated pet owners, represented in FIG. 1 by the pet owner devices 110, 114. Next, at step 304, the server 104 associates the at least one attraction module with received selection data, with respect to the plurality of associated pet owners. As will be appreciated by a skilled artisan, in accordance with one embodiment of the subject application, the attraction module is capable of being selected from the group consisting of meeting friends, pet advice, veterinarian answers, memorial postings, weekly pet horoscopes, pet fashions for sale, pets in the news, and hero of the week. Those skilled in the art will further recognize that in accordance with one embodiment of the subject application, the attraction module is capable of being representative of a link relating to at least one of the group consisting of pet rescue, pet breeding, and pet adoption. The attraction module is further capable of being representative of a pet beauty contest selected from the group consisting of monthly pet's photos, pet-owner look a-likes, and pets dressed up, wherein the pet beauty contest is judged by users of the subject system and method. As will be further understood by one skilled in art, the attraction module is further capable of being representative of online text-based communication, and is selected from the group consisting of frequently asked questions, problem solving, training and handling tips, and synchronous conferencing. The latter is capable of being accomplished by using a variety of protocols and programs, as known in the art, such as Talker, Instant messenger, Skype, Adium, Meetro, and the like.

Once the server 104 associates the received selection data with respect to the plurality of associated pet owners, with at least one attraction module, flow proceeds to step 306, whereupon a component of the server 104 generates at least one user interface corresponding to the at least one attraction module in accordance with association performed by the respective component of the server 104. The user interface is, preferably, comprised of a plurality of interface display frames in a hierarchical structure, as known in the art. Flow then proceeds to step 308, at which step the user interface generated by the server 104 is then displayed to associated pet owners on respective pet owner devices 110, 114. Then, at step 310, interaction is accomplished between the plurality of associated pet owners via the at least one user interface from remote locations of respective pet owner devices 110, 114.

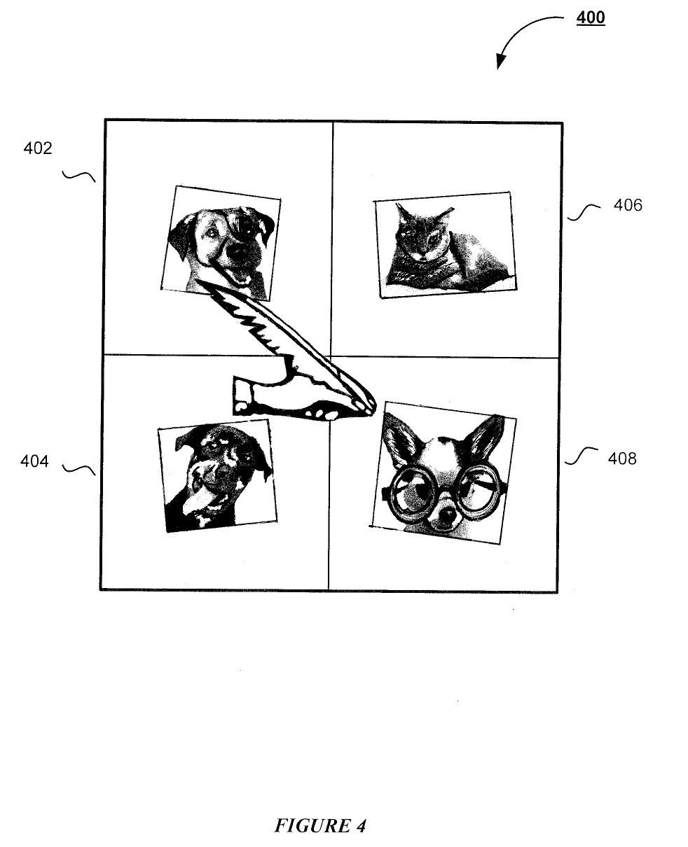

As will be appreciated by a skilled artisan, illustrated in FIG. 4 is an example of a fragment 400 of a user interface for use in the system and method for interactive communication for associated pet owners according to one embodiment the subject application with pet's photos 402, 404, 406, and 408 incorporated therein.

A will be further recognized by those skilled in the art, the system and method for interactive communication for associated pet owners described herein unifies and connects pets and pet lovers around the world through a like minded communication venue. The system according to the subject application delivers smiles with daily humor to associated pet owners and offers comprehensive information on all pet related topics. The system and method described herein is an interactive communication tool for pets and their owners and offers like minded pet lovers around the world an opportunity to interact via the Internet. The system allows visitors to converse person to person or pet to pet (in third person). In addition, fullnatured humor is the cornerstone of the system.

The invention extends to computer programs in the form of source code, object code, code intermediate sources and partially compiled object code, or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the principles of the subject application as described, will fall within the scope of the subject application.

The foregoing description of a preferred embodiment of the subject application has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the subject application and its practical application to thereby enable one of ordinary skill in the art to use the invention in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for interactive communication for associated pet owners comprising:
means adapted for receiving, from a plurality of associated pet owners, selection data inclusive of attraction data;
association means adapted for associating at least one attraction module with received selection data with respect to the plurality of associated pet owners;
means adapted for generating at least one user interface corresponding to the at least one attraction module in accordance with association performed by the association means;
means adapted for displaying, to the plurality of associated pet owners, the at least one user interface corresponding to the at least one attraction module; and
means adapted for accomplishing interaction between the plurality of associated pet owners via the at least one user interface from remote locations.

2. The system for interactive communication for associated pet owners of claim 1 wherein the at least one attraction module is selected from the group consisting of meeting friends, pet advice, veterinarian answers, memorial postings, weekly pet horoscopes, pet fashions for sale, pets in the news, and hero of the week.

3. The system for interactive communication for associated pet owners of claim 1 wherein the at least one attraction module is representative of a link relating to at least one of the group consisting of pet rescue, pet breeding, and pet adoption.

4. The system for interactive communication for associated pet owners of claim 1 wherein the at least one attraction module is representative of a pet beauty contest selected from the group consisting of monthly pet's photos, pet-owner look a-likes, and pets dressed up, wherein the pet beauty contest is judged by pet fans.

5. The system for interactive communication for associated pet owners of claim 1 wherein the at least one attraction module is representative of online text-based communication, and is selected from the group consisting of frequently asked questions, problem solving, training and handling tips, and synchronous conferencing.

6. The system for interactive communication for associated pet owners of claim 1 wherein the at least one user interface is comprised of a plurality of interface display frames in a hierarchical structure.

7. A method for interactive communication for associated pet owners comprising:
receiving, from a plurality of associated pet owners, selection data inclusive of attraction data;
associating at least one attraction module with received selection data with respect to the plurality of associated pet owners;
generating at least one user interface corresponding to the at least one attraction module in accordance with an output of the association step;
displaying, to the plurality of associated pet owners, the at least one user interface corresponding to the at least one attraction module; and
accomplishing interaction between the plurality of associated pet owners via the at least one user interface from remote locations.

8. The method for interactive communication for associated pet owners of claim 7 wherein the at least one attraction module is selected from the group consisting of meeting friends, pet advice, veterinarian answers, memorial postings, weekly pet horoscopes, pet fashions for sale, pets in the news, and hero of the week.

9. The method for interactive communication for associated pet owners of claim 7 wherein the at least one attraction module is representative of a link relating to at least one of the group consisting of pet rescue, pet breeding, and pet adoption.

10. The method for interactive communication for associated pet owners of claim 7 wherein the at least one attraction module is representative of a pet beauty contest selected from the group consisting of monthly pet's photos, pet-owner look a-likes, and pets dressed up, wherein the pet beauty contest is judged by pet fans.

11. The method for interactive communication for associated pet owners of claim 7 wherein the at least one attraction module is representative of online text-based communication, and is selected from the group consisting of frequently asked questions, problem solving, training and handling tips, and synchronous conferencing.

12. The method for interactive communication for associated pet owners of claim 7 wherein the at least one user interface is comprised of a plurality of interface display frames in a hierarchical structure.

13. A computer-implemented method for interactive communication for associated pet owners comprising:
receiving, from a plurality of associated pet owners, selection data inclusive of attraction data;
associating at least one attraction module with received selection data with respect to the plurality of associated pet owners;
generating at least one user interface corresponding to the at least one attraction module in accordance with the association step;
displaying, to the plurality of associated pet owners, the at least one user interface corresponding to the at least one attraction module; and
accomplishing interaction between the plurality of associated pet owners via the at least one user interface from remote locations.

14. The computer-implemented method for interactive communication for associated pet owners of claim 13 wherein the at least one attraction module is selected from the group consisting of meeting friends, pet advice, veterinarian answers, memorial; postings, weekly pet horoscopes, pet fashions for sale, pets in the news, and hero of the week.

15. The computer-implemented method for interactive communication for associated pet owners of claim 13 wherein the at least one attraction module is representative of a link relating to at least one of the group consisting of pet rescue, pet breeding, and pet adoption.

16. The computer-implemented method for interactive communication for associated pet owners of claim 13 wherein the at least one attraction module is representative of a pet beauty contest selected from the group consisting of monthly pet's photos, pet-owner look a-likes, and pets dressed up, wherein the pet beauty contest is judged by pet fans.

17. The computer-implemented system for interactive communication for associated pet owners of claim 13 wherein the at least one attraction module is representative of online text-based communication, and is selected from the group consisting of frequently asked questions, problem solving, training and handling tips, and synchronous conferencing.

18. The computer-implemented system for interactive communication for associated pet owners of claim 13 wherein the at least one user interface is comprised of a plurality of interface display frames in a hierarchical structure.
